(19) United States
(12) Patent Application Publication
(10) Pub. No.: US 2023/0098592 A1
(43) Pub. Date: Mar. 30, 2023

(54) METHOD OF REFINERY PROCESSING OF RENEWABLE NAPHTHA

(71) Applicant: ExxonMobil Technology and Engineering Company, Annandale, NJ (US)

(72) Inventors: William J. Novak, Bedminster, NJ (US); Samuel J. Cady, Morristown, NJ (US); Brandon J. O'Neill, Spring, TX (US)

(21) Appl. No.: 17/932,068

(22) Filed: Sep. 14, 2022

Related U.S. Application Data
(60) Provisional application No. 63/261,692, filed on Sep. 27, 2021.

(51) Int. Cl. C10G 69/10; C10G 3/00; C10G 45/58; C10G 35/04; C10G 7/00; C10G 47/00

(52) U.S. Cl. CPC C10G 69/10; C10G 3/50; C10G 45/58; C10G 35/04; C10G 7/00; C10G 47/00; C10G 2300/1014; C10G 2300/1018; C10G 2300/305; C10G 2400/04; C10G 2400/02; C10G 2300/4081

(57) ABSTRACT

This application relates to renewable diesel production and to production of renewable naphtha in a renewable diesel unit. Disclosed herein is an example of a method of renewable diesel production. Examples embodiments of the method may include hydrotreating the biofeedstock by reaction with hydrogen to form a hydrotreated biofeedstock; contacting at least a portion of the hydrotreated biofeedstock with a dewaxing catalyst to produce a renewable diesel product and a renewable naphtha product; separating the renewable diesel product and the renewable naphtha product in a product splitter; and monitoring an octane number of the renewable naphtha product with an analyzer.

### CROSS-REFERENCE TO RELATED APPLICATIONS

This application claims the benefit of U.S. Provisional Application No. 63/261,692, filed on Sep. 27, 2021, the entire contents of which are incorporated herein by reference FIELD

This application relates to renewable diesel production and, in particular embodiments, to production of renewable naphtha in a renewable diesel unit.

### BACKGROUND

Renewable diesel is a hydrocarbon fuel made from vegetable oils, fats, greases, or other suitable biofeedstocks. In contrast to biodiesels, renewable diesels are not esters and are chemically similar to petroleum diesels. In some instances, renewable diesel is used as a blendstock for blending with petroleum diesel. Although a number of different techniques can be used for renewable diesel production, an example process includes hydrotreatment of a biofeedstock followed by isomerization to dewax the renewable diesel. Dewaxing, also referred to as isomerization, may be used to convert the highly paraffinic hydrotreatment unit effluent to iso-paraffins which have the required physical properties for diesel. Diesel fuels have requirements for cold flow, cloud point, and other physical properties which may vary depending on season and location. In the United States, diesel specifications can be found in ASTM D975 titled the Standard Specification for Diesel fuel Oils. One method of controlling the properties of renewable diesel is to adjust the process severity at which the dewaxing unit operates during different parts of the year.

A secondary product of the renewable diesel process is renewable naphtha which may be separated from the renewable diesel product after dewaxing. The composition of the renewable naphtha is dependent upon the process severity of the dewaxing unit and therefore the renewable naphtha stream will vary seasonally as the diesel property requirements change. The variation in renewable naphtha composition is larger than the seasonal change in composition of other refinery naphtha and requires specialized methods for optimal processing. In industry, the renewable naphtha fraction has been viewed as a minor product and not subject to much consideration for further processing. However, as the demand for renewable diesel increases and renewable diesel plants become larger, the volume of renewable naphtha produced will also increase, thereby requiring new processing techniques to address the unique challenges of renewable naphtha.

### SUMMARY

According to various embodiments, the present invention provides a method of renewable diesel production. According to various embodiments, the method may include hydrotreating the biofeedstock by reaction with hydrogen to form a hydrotreated biofeedstock; contacting at least a portion of the hydrotreated biofeedstock with a dewaxing catalyst to produce a renewable diesel product and a renewable naphtha product; separating the renewable diesel product and the renewable naphtha product in a product splitter; and monitoring an octane number of the renewable naphtha product with an analyzer.

Disclosed herein is an exemplary system for production of renewable diesel production. Examplary embodiments of the system may include a hydrotreatment stage comprising a hydrodeoxygenation reactor that receives a biofeedstock; a dewaxing stage comprising a dewaxing reactor that receives a hydrotreated product stream from the hydrotreatment stage and generates a dewaxed product stream, and a product separator that receives the dewaxed product stream from the dewaxing reactor and generates a renewable diesel stream and a renewable naphtha stream; and an analyzer positioned to analyze the renewable naphtha stream.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 depicts an example renewable diesel production system in accordance with one or more embodiments;

FIG. 2 depicts another example renewable diesel production system in accordance with one or more embodiments;

FIG. 3 depicts an example renewable naphtha processing system in accordance with one or more embodiments;

FIG. 4 depicts an example renewable naphtha processing system integrated with an iso/normal separation processing system accordance with one or more embodiments; and

FIG. 5 depicts an example renewable naphtha processing system integrated with a jet production system accordance with one or more embodiments.

### DETAILED DESCRIPTION

This application relates to renewable diesel production and, in particular, to the processing of renewable naphtha associated with the production of renewable diesel. In some embodiments, an analyzer is utilized to analyze the composition of the renewable naphtha thereby allowing a determination to be made how to optimally process the renewable naphtha. According to an embodiment of the invention, the analyzer may include any suitable analyzer such as offline analyzers, at line analyzers, online analyzers, and inline analyzers. In in certain embodiments an online analyzer such as an online spectrometer and/or octane sensor may be utilized for actively monitoring compositional changes of the renewable naphtha after dewaxing. In some embodiments, the analyzer may include an offline analyzer which may be utilized periodically for monitoring compositional changes of the renewable naphtha after dewaxing.

In accordance with various present embodiments, renewable diesel production includes a hydrotreating stage. Embodiments of the hydrotreating stage include conversion by reaction with hydrogen to form, for example, paraffin products. Several reactions may occur in the hydrotreating stage including hydrogenation, hydrodeoxygenation, and hydrodemetallization, for example. The hydrotreated reactor effluent includes, for example, paraffinic n-alkane hydrocarbons. Particular embodiments for renewable diesel production further include a dewaxing stage that receives hydrotreated reactor effluent from the hydrotreating stage. Embodiments of the dewaxing stage include catalytic dewaxing of the hydrotreated reactor effluent, for example, by removal and/or isomerization of long chain paraffinic molecules, such as molecules ranging from 12 carbons long to 24 carbons long or from 16 carbons long to 22 carbons long. Thus, the dewaxing stage effluent contains, for example, hydrocarbon molecules ranging from 3 carbons long to 24 carbons long. In some embodiments, the renewable diesel portion is considered the fraction of the dewaxing stage effluent which contains hydrocarbons carbon numbers ranging from C12-C24 or greater. In some embodiments, the fraction of the dewaxing stage effluent which contains hydrocarbons with carbon numbers ranging from C3 to C12 is considered the renewable naphtha. The total yield of renewable naphtha ranges, for example, from 1% to 10% by mass of the dewaxing stage effluent. In some embodiments, the effluent from the dewaxing stage is separated in a product separator to produce a stream containing renewable naphtha and a stream containing renewable diesel.

As discussed above, the composition of renewable naphtha produced may vary depending on dewaxing severity. In summer months, the dewaxing severity may be relatively lower which may yield a renewable naphtha with a greater fraction of n-paraffins to iso-paraffins and a relatively higher cloud point. In winter months, the dewaxing severity may be relatively higher which may yield a renewable naphtha with a greater fraction of iso-paraffins to n-paraffins and a relatively lower cloud point. In general, higher severity dewaxing may generate more iso-paraffins than lower severity dewaxing. The yield of naphtha may be a function of dewaxing severity where yields will be lower at relatively lower severity and higher at relatively higher severity.

The renewable naphtha produced may have a relatively low octane rating rendering it unsuitable for use in blending fuels or as a naphtha feedstock for other processes. Renewable naphtha containing relatively higher mass fraction of iso-paraffins generally have a higher octane number and may be used directly in blending of fuels. Renewable naphtha containing a relatively lower mass fraction of iso-paraffins generally may have a lower octane number and may require further processing to form a useable fuel or as a feedstock to a separate unit. Another intermediate condition may exist where the renewable diesel contains a fraction of hydrocarbons that may be utilized in fuel blending and a fraction which requires further processing. In accordance with one or more embodiments, an analyzer is utilized to determine where the renewable naphtha should be routed to for optimal processing.

To monitor conversion of the renewable naphtha in the dewaxing stage, example embodiments use an analyzer, such as a spectrometer, octane sensor, or other suitable analyzer, for example, to determine octane number. In some embodiments, the analyzer includes an infrared spectrometer, a near infrared spectrometer, or a Raman spectrometer. In some embodiments, the analyzer is positioned downstream of the dewaxing stage. The analyzer samples, for example, the effluent from the dewaxing stage or another stream downstream of the dewaxing stage to determine the octane number for the stream. The analyzer may utilize any suitable analysis technique, such as a dielectric constant method for example, to calculate an octane number for the stream. By monitoring octane levels, in some embodiments, a determination is made to the optimal processing of the renewable naphtha for different applications. Whether renewable naphtha can be directly blended into fuels is a function of both the naphtha octane and naphtha volume produced. For example, if the renewable naphtha fraction is large and is to be used in fuel blending, the octane number must be high enough to meet applicable industry standards. If the octane number is not high enough, in some embodiments, the renewable naphtha is routed to a reforming unit to increase octane number. In accordance with one or more embodiments, the use of an analyzer provides several advantages over traditional techniques that use offline analysis where a sample is taken to a lab for analysis. By way of example, the analyzer monitors downstream of the dewaxing stage in real time with minimal personnel involvement by process operators. With real time monitoring, in one or more embodiments, process changes are implemented to efficiently route the renewable naphtha to appropriate units to maximize the utility of the renewable naphtha.

Examples of embodiments include a process for renewable diesel production. Renewable diesel is a hydrocarbon made from biofeedstocks, including vegetable oils, fats, greases, or other sources of triglycerides, which include, for example, various crops, waste oil, or other animal fats. As used herein, the term “renewable diesel” refers to a hydrocarbon liquid produced from a biofeedstock and with paraffins as a major component. Because renewable diesel is chemically similar to petroleum diesel, renewable diesel is capable of use in diesel engines without engine modification. In one example, a renewable diesel includes between 50% to 99% by weight of paraffins. A 100% renewable diesel should meet the ASTM D975 specification for diesel fuel.

In accordance with present embodiments, the renewable diesel is produced from a biofeedstock. Any of a variety of suitable biofeedstocks may be used in the production of the renewable diesel. The biofeedstock is derived, for example, from a biological raw material component such as vegetable, animal, fish, and/or algae. Suitable biofeedstocks include, but are not limited to, vegetable oils, animal fats, fish oils, pyrolysis oils, and algae lipids/oils, as well as components of such materials, and in some embodiments can specifically include one or more type of lipid compounds. As used herein, vegetable fats/oils refer to any plant-based material and includes, but is not limited to, fat/oils derived from a source such as plants of the genus Jatropha. In some embodiments, the biofeedstock includes biodiesel, also referred to as fatty acid methyl ester. In some embodiments, the biofeedstock includes free fatty acids.

Examples of the biofeedstock include lipid compounds, which are typically biological compounds that are insoluble in water, but soluble in nonpolar (or fat) solvents. Non-limiting examples of such solvents include alcohols, ethers, chloroform, alkyl acetates, benzene, and combinations thereof. Major classes of lipids include, but are not necessarily limited to, fatty acids, glycerol-derived lipids (including fats, oils and phospholipids), sphingosine-derived lipids (including ceramides, cerebrosides, gangliosides, and sphingomyelins), steroids and their derivatives, terpenes and their derivatives, fat-soluble vitamins, certain aromatic compounds, and long-chain alcohols and waxes. In living organisms, lipids generally serve as the basis for cell membranes and as a form of fuel storage. Lipids can also be found conjugated with proteins or carbohydrates, such as in the form of lipoproteins and lipopolysaccharides.

Examples of the biofeedstock include vegetable oils. Examples of suitable vegetable oils include, but are not limited to, rapeseed (canola) oil, soybean oil, coconut oil, sunflower oil, palm oil, palm kernel oil, peanut oil, linseed oil, tall oil, corn oil, castor oil, jatropha oil, jojoba oil, olive oil, flaxseed oil, camelina oil, safflower oil, babassu oil, tallow oil, and rice bran oil. Vegetable oils as referred to herein can also include processed vegetable oil material. Non-limiting examples of processed vegetable oil material include fatty acids and fatty acid alkyl esters. Alkyl esters typically include C₁-C₅ alkyl esters. In some embodiments, the processed vegetable oil material includes one or more of methyl, ethyl, and propyl esters.

Examples of the biofeedstock include animal fats. Examples of suitable animal fats include, but are not limited to, beef fat (tallow), hog fat (lard), turkey fat, fish fat/oil, and chicken fat. The animal fats can be obtained from any suitable source including restaurants and meat production facilities. Animal fats as referred to herein also include processed animal fat material. Non-limiting examples of processed animal fat material include fatty acids and fatty acid alkyl esters. Alkyl esters typically include C₁-C₅ alkyl esters. In some embodiments, processed animal fat material includes one or more of methyl, ethyl, and propyl esters.

Examples of the biofeedstock include algae oils or lipids, including, not limited to, lipids typically contained in algae in the form of membrane components, storage products, and metabolites. Certain algal strains, particularly microalgae such as diatoms and cyanobacteria, contain proportionally high levels of lipids. Algal sources for the algae oils can contain varying amounts, e.g., from 2 weight percent (“wt. %”) to 40 wt. % of lipids, based on total weight of the biomass itself. Examples of suitable algal sources for algae oils include, but are not limited to, unicellular and multicellular algae. Examples of such algae include a rhodophyte, chlorophyte, heterokontophyte, tribophyte, glaucophyte, chlorarachniophyte, euglenoid, haptophyte, cryptomonad, dinoflagellum, phytoplankton, and the like, and combinations thereof. In one embodiment, algae can be of the classes Chlorophyceae and/or Haptophyta. Examples of specific species include, but are not limited to, Neochloris oleoabundans, Scenedesmus dimorphus, Euglena gracilis, Phaeodactylum tricornutum, Pleurochrysis carterae, Prymnesium parvum, Tetraselmis chui, and Chlamydomonas reinhardtii.

Examples of the biofeedstock include feedstocks that primarily include triglycerides and free fatty acids (FFAs). The triglycerides and FFAs typically contain aliphatic hydrocarbon chains in their structure having from 8 to 36 carbons, for example, from 10 to 26 carbons or 14 to 22 carbons. Types of triglycerides can be determined according to their fatty acid constituents. The fatty acid constituents can be readily determined using Gas Chromatography (GC) analysis. This analysis involves extracting the fat or oil, saponifying (hydrolyzing) the fat or oil, preparing an alkyl (e.g., methyl) ester of the saponified fat or oil, and determining the type of (methyl) ester using GC analysis. In one embodiment, a majority (i.e., greater than 50%) of the triglyceride present in the lipid material can include C₁₀ to C₂₆ fatty acid constituents, based on total triglyceride present in the lipid material. Further, a triglyceride is a molecule having a structure substantially identical to the reaction product of glycerol and three fatty acids. Thus, although a triglyceride is described herein as being including fatty acids, it should be understood that the fatty acid component does not necessarily contain a carboxylic acid hydrogen. In one embodiment, a majority of triglycerides present in the biocomponent feed can include C₁₂ to C₁₈ fatty acid constituents, based on total triglyceride content. Other types of feed that are derived from biological raw material components can include fatty acid esters, such as fatty acid alkyl esters (e.g., FAME and/or FAEE).

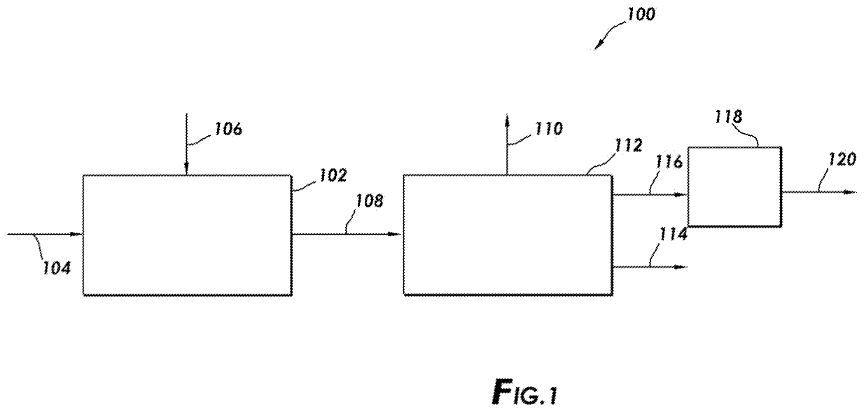

FIG. 1 is a block diagram illustrating a system 100 for renewable diesel production in accordance with some embodiments. As illustrated, embodiments of the system 100 include the following stages: (i) a hydrotreating stage 102 in which a biofeed stream 104 containing a biofeedstock can be reacted with hydrogen from a hydrogen stream 106 to remove oxygen from the biofeedstock; and (ii) a dewaxing stage 112 that receives a hydrotreated product stream 108 containing hydrotreated biofeedstock and catalytically dewaxes the hydrotreated biofeedstock to produce a renewable diesel product 114 with improved cold flow properties and renewable naphtha 116. In the illustrated embodiments, an analyzer 118 analyzes renewable naphtha 116 to monitor octane number of the renewable naphtha. By way of example, the analyzer 118 measures concentration of certain species (such as those which contribute to the octane number) in the renewable naphtha 116, to determine if renewable naphtha 116 requires further processing. Analyzer 188 may include any of the previously discussed analyzer types. For example, renewable naphtha 116 is routed through stream 120 to a downstream unit (not illustrated) which further processes renewable naphtha 116. For example, should renewable naphtha 116 have an octane number that does not meet fuel blending requirements, stream 120 is routed to reforming.

In the hydrotreating stage 102, embodiments include combining the biofeed stream 104 with the hydrogen stream 106 containing hydrogen. While FIG. 1 illustrates separate addition of the biofeed stream 104 and the hydrogen stream 106 to the hydrotreating stage 102, embodiments may include combination of the biofeed stream 104 and the hydrogen stream 106 prior to the hydrotreating stage 102. The hydrotreating stage 102 should remove oxygen from the biofeedstock in the biofeed stream 104 by reaction with hydrogen in the hydrogen stream 106. The reaction in the hydrotreating stage 102 should produce hydrotreated biofeedstock, including paraffin products, reaction intermediates, and unreacted biofeedstock and hydrogen. Reaction intermediates include, for example, esters, acids, and ketones, alcohols, among others.

In some embodiments, the hydrotreating stage 102 includes a hydrotreatment catalyst. Examples of suitable hydrotreatment catalyst contain at least one of Group VIB and/or Group VIII metals, optionally on a support such as alumina or silica. Examples of suitable hydrotreatment catalyst include, but are not limited to, NiMo, CoMo, and NiW supported catalysts. The hydrotreating stage 102 can be operated at any suitable conditions that are effective for hydrotreatment. Effective hydrotreatment conditions include, but are not limited to, a temperature of 500° F. (260° C.) or higher, for example, 550° F. (288° C.) or higher, 600° F. (316° C.) or higher, or 650° F. (343° C.) or higher. Additionally, or alternately, the temperature can be 750° F. (399° C.) or less, for example 700° F. (371° C.) or less, or 650° F. (343° C.) or less. Effective hydrotreatment conditions can additionally or alternately include, but are not limited to, a total pressure of 400 psig (2.8 MPag) or more, for example, 500 psig (3.4 MPag) or more, 750 psig (5.2 MPag) or more, or 1000 psig (6.9 MPag) or more. Additionally or alternately, the total pressure can be 2000 psig (10.3 MPag) or less, for example 1200 psig (8.2 MPag) or less, 1000 psig (6.9 MPag) or less, or 800 psig (5.5 MPag) or less. In some embodiments, the hydrotreating conditions can include, but are not necessarily limited to, a temperature of 315° C. to 425° C. and a total pressure of 300 psig (2.1 MPag) to 3000 psig (21 MPag).

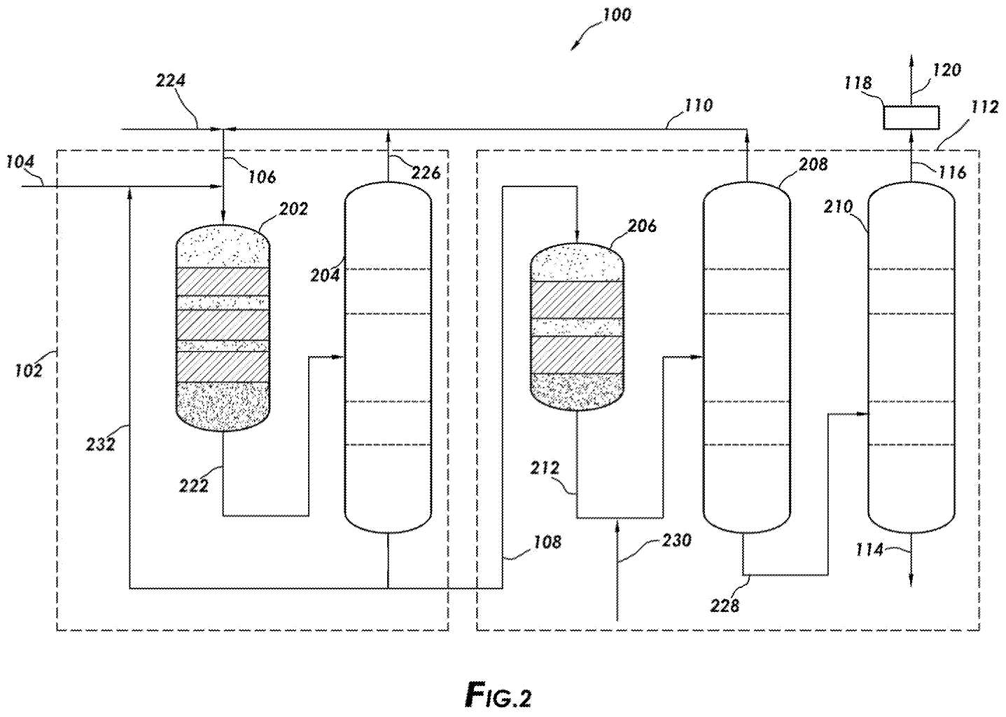

Although not shown on FIG. 1, a separation device (e.g., hydrotreating separator 204 on FIG. 2) can be used to separate out light streams (e.g., hydrogen, carbon dioxide, carbon monoxide) prior to passing the hydrotreated biofeedstock to the dewaxing stage 112. Examples of suitable separation devices include, but are not limited to, a separator, a stripper, a fractionator, or another device suitable for separating gas-phase products from liquid-phase products. For example, a separation device can be used to remove unreacted hydrogen and/or at least a portion of any H₂S and/or NH₃ formed during hydrotreatment, e.g., with the remainder of the H₂S and/or NH₃ formed during hydrotreatment being cascaded to the dewaxing stage 112, as desired. Alternately, the entire effluent from the hydrotreating stage 102 can be cascaded to the dewaxing stage 112, if desired.

As previously described, the hydrotreating stage 102 should at least partially deoxygenate the biofeedstock in the biofeed stream 104. Deoxygenating the biofeedstock can avoid problems with catalyst poisoning or deactivation due to the creation of water or carbon oxides during the subsequent catalytic dewaxing in the dewaxing stage 112. The hydrotreating stage 102 can be used to substantially deoxygenate the biofeedstock. This corresponds to removing 90% or more, for example, 95% or more, 98% or more, 99% or more, 99.5% or more, 99.9% or more, or completely (measurably) all the oxygen present in the biofeedstock. Alternately, substantially deoxygenating the biofeedstock can correspond to reducing the oxygenate level of the hydrotreated biofeedstock to 0.1 wt. % or less, for example, 0.05 wt. % or less, 0.03 wt. % or less, 0.02 wt. % or less, 0.01 wt. % or less, 0.005 wt. % or less, 0.003 wt. % or less, 0.002 wt. % or less, or 0.001 wt. % or less.

Although embodiments may include deoxygenation as the primary reaction in hydrotreating stage 102, there may be several other reactions occurring in hydrotreating stage 102 to produce renewable diesel. For example, embodiments of the hydrotreating stage 102 include saturation of the olefins in biofeed stream 104 to produce saturated paraffins. Should biofeed stream 104 contain triglycerides, embodiments of the hydrotreating stage 102 include breaking the triglyceride into the corresponding oleaginous compounds. Examples of the hydrotreating stage 102 also facilitate hydrodesulfurization by forming hydrogen sulfide from sulfur containing compounds, hydrodenitrogenation by removing nitrogen as ammonia, and hydrodemetallization to remove metal species from biofeed stream 104.

The system 100 include the analyzer 118 to determine the optimal processing for the renewable naphtha, in accordance with present embodiments. The analyzer 118 is positioned, for example, to analyze renewable naphtha 116 from dewaxing stage 112. The analyzer 118 may be positioned at any suitable location for monitoring renewable naphtha 116. In the illustrated embodiment, the analyzer 118 is positioned after dewaxing stage 112. In some embodiments, the analyzer 118 may be positioned to measure the effluent from a product separator (e.g., product separator 210 on FIG. 2). In some embodiments, the analyzer 118 may be positioned to measure the effluent products from a reactor (e.g., dewaxing reactor 206 on FIG. 2) in the dewaxing stage 112. In example embodiments, the analyzer 118 analyzes all or a portion of a stream. For example, the analyzer 118 can measure a slipstream of the dewaxing reactor effluent 212 (shown on FIG. 2) and/or renewable naphtha 116. Should the measurements from the analyzer 118 indicate the octane number is too low for fuel blending, examples embodiments include routing of the stream 120 to different units for upgrading the octane number or use as a feedstock in a separate fuels process.

In some embodiments, the dewaxing stage 112 includes catalytically dewaxing at least a portion of the hydrotreated biofeedstock in the hydrotreated product stream 108 to produce a renewable diesel product 114 with improved its cold flow properties, such as pour point and/or cloud point. Catalytic dewaxing relates to the removal and/or isomerization of long chain paraffinic molecules from the hydrotreated biofeedstock. In accordance with present embodiments, catalytic dewaxing includes selective hydrocracking or hydroisomerization of these long chain molecules. In addition to renewable diesel product 114, dewaxing gas stream 110 also exits the dewaxing stage 112 in accordance with one or more embodiments. The dewaxing gas stream 110 contains, for example, hydrogen and other gases generated in the dewaxing stage 112.

The dewaxing stage 112 can include a dewaxing catalyst. In some embodiments, the dewaxing catalyst can include molecular sieves such as crystalline aluminosilicates (zeolites) and/or silicoaluminophosphates (SAPOs). For example, the molecular sieve can be a 1-D or 3-D molecular sieve. By way of further example, the molecular sieve can be a 10-member ring 1-D molecular sieve (e.g., ZSM-48). Examples of molecular sieves can include, but are not limited to, ZSM-48, ZSM-23, ZSM-35, Beta, USY, ZSM-5, and combinations thereof. In an embodiment, the molecular sieve can include or be ZSM-48, ZSM-23, or a combination thereof. The dewaxing catalyst can optionally include a binder, such as alumina, titania, silica, silica-alumina, zirconia, or a combination thereof. In an embodiment, the binder can include or be alumina, titania, or a combination thereof. In another embodiment, the binder can include or be titania, silica, zirconia, or a combination thereof.

The dewaxing catalyst can also include a metal hydrogenation component, such as a Group VIII metal. Suitable Group VIII metals can include, but are not limited to, Pt, Pd, Ni, and combinations thereof. The dewaxing catalyst can advantageously include 0.1 wt. % or more of the Group VIII metal, for example, 0.3 wt. % or more, 0.5 wt. % or more, 1.0 wt. % or more, 2.0 wt. % or more, 2.5 wt. % or more, 3.0 wt. % or more, or 5.0 wt. % or more. Additionally or alternately, the dewaxing catalyst can include 10.0 wt. % or less of a Group VIII metal, for example 7.0 wt. % or less, 5.0 wt. % or less, 3.0 wt. % or less, 2.5 wt. % or less, 2.0 wt. % or less, or 1.5 wt. % or less.

In some embodiments, particularly when Group VIII metal is a non-noble metal such as Ni, the dewaxing catalyst additionally includes a Group VIB metal, such as W and/or Mo. For instance, in one embodiment, the dewaxing catalyst includes Ni and W, Ni and Mo, or a combination of Ni, Mo, and W. In certain such embodiments, the dewaxing catalyst includes 0.5 wt. % or more of the Group VIB metal, for example, 1.0 wt. % or more, 2.0 wt. % or more, 2.5 wt. % or more, 3.0 wt. % or more, 4.0 wt. % or more, or 5.0 wt. % or more. Additionally or alternately, the dewaxing catalyst includes, for example, 20.0 wt. % or less of a Group VIB metal, for example 15.0 wt. % or less, 12.0 wt. % or less, 10.0 wt. % or less, 8.0 wt. % or less, 5.0 wt. % or less, 3.0 wt. % or less, or 1.0 wt. % or less. In one particular embodiment, the dewaxing catalyst includes only a Group VIII metal selected from Pt, Pd, and a combination thereof.

Examples of embodiments of the catalytic dewaxing include exposing the hydrotreated biofeedstock to a dewaxing catalyst (that may, and usually does, also have isomerization activity) under effective (catalytic) dewaxing (and/or isomerization) conditions. Example dewaxing conditions include, but are not limited to, a temperature of 500° F. (260° C.) or higher, for example, about 550° F. (288° C.) or higher, 600° F. (316° C.) or higher, or 650° F. (343° C.) or higher. Additionally, or alternately, the temperature can be 750° F. (399° C.) or less, for example 700° F. (371° C.) or less, or 650° F. (343° C.) or less. Example of effective dewaxing conditions can additionally or alternately include, but are not limited to, a total pressure of 200 psig (1.4 MPag) or more, for example, 250 psig (1.7 Mpag) or more, 500 psig (3.4 MPag) or more, 750 psig (5.2 MPag) or more, or 1000 psig (6.9 MPag) or more. Additionally or alternately, the total pressure can be 1500 psig (10.3 MPag) or less, for example 1200 psig (8.2 MPag) or less, 1000 psig (6.9 MPag) or less, or 800 psig (5.5 MPag) or less.

FIG. 2 illustrates an example of the system 100 for renewable diesel production in accordance with some embodiments. In the illustrated embodiment, the system 100 includes the hydrotreating stage 102 and the dewaxing stage 112. The hydrotreating stage 102 includes, for example, a hydrodeoxygenation reactor 202 and a hydrotreating separator 204. The dewaxing stage 112 includes, for example, a dewaxing reactor 206, a dewaxing separator 208, and a product separator 210. As shown in FIG. 2, analyzer 118 is positioned after dewaxing stage 112 in accordance with one or more embodiments. Alternatively, analyzer 118 may be positioned to measure dewaxing reactor effluent 212 or dewaxing separator bottoms 228. In operation, embodiments include introduction of a biofeedstock stream 104 and a hydrogen stream 106 into the hydrotreating stage 102. In the illustrated embodiment, the biofeedstock stream 104 and the hydrogen stream 106 are combined and introduced into the hydrodeoxygenation reactor 202. However, it should be understood that these streams may alternatively be separately introduced to the hydrodeoxygenation reactor 202. The hydrotreatment in the hydrodeoxygenation reactor 202 is discussed in the preceding sections. In the illustrated embodiment, the hydrodeoxygenation reactor effluent stream 222 flows from the hydrodeoxygenation reactor 202 into a hydrotreating separator 204 for separation of the gas-phase products from the liquid-phase products. Embodiments include withdrawal of the liquid-phase products from the hydrotreating separator 204 as hydrotreated product stream 108. Embodiments include withdrawal of the gas-phase products from the hydrotreating separator 204 as hydrotreated gas recycle stream 226. In the illustrated embodiment, the hydrotreated gas recycle stream 226 is combined with the dewaxing gas stream 110 from the dewaxing separator 208 to form the hydrogen stream 106 fed to the hydrodeoxygenation reactor 202. As illustrated, makeup hydrogen stream 224 can also be combined into the hydrogen stream 106 as needed. Additionally, makeup hydrogen stream 230 may be introduced into dewaxing reactor effluent 212 or directly into dewaxing reactor 206. In the illustrated embodiment, a portion of hydrotreated product stream 108 is separated and reintroduced to hydrodeoxygenation reactor 202 as quench stream 232.

In the illustrated embodiment, the system 100 further include introduction of the hydrotreated product stream 108 into the dewaxing stage 112. For example, the hydrotreated product stream 108 is introduced into dewaxing reactor 206. The dewaxing that occurs in the dewaxing reactor 206 is discussed in the preceding sections. The dewaxing reactor effluent 212 is introduced, for example, into a dewaxing separator 208 for separation of the gas-phase products from the liquid-phase products. In the illustrated embodiment, the gas-phase products are withdrawn from the dewaxing separator 208 as dewaxing gas stream 110 and combined with the hydrotreated gas recycle stream 226 for recycle to the hydrodeoxygenation reactor 202. In the illustrated embodiment, liquid-phase products are withdrawn from the dewaxing separator 208 as dewaxing separator bottoms 228 which may be introduced into product separator 210. Although shown as one unit, product separator 210 may include several unit operations such as steam stripping, distillation, and quenching, for example, to separate the renewable naphtha portion from the renewable diesel portion of dewaxing separator bottoms 228. In some embodiments, renewable naphtha 116 and renewable diesel product 114 are withdrawn from product separator 210. In accordance with present embodiments, renewable naphtha 116 are introduced into analyzer 118 from where a determination may be made to route stream 120.

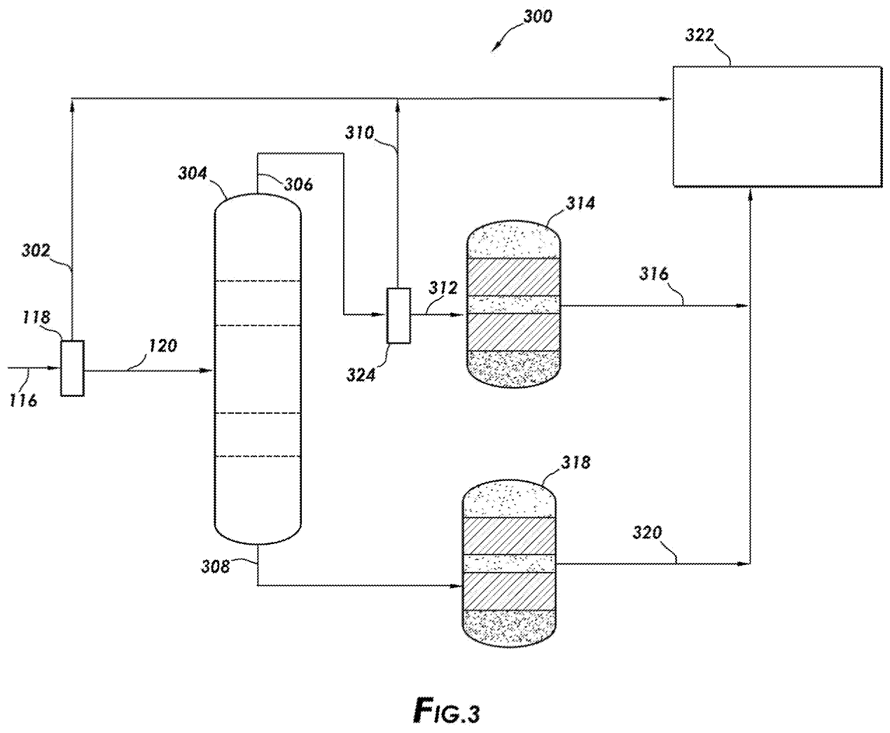

FIG. 3 illustrates depicts an example renewable naphtha processing system 300 in accordance with some embodiments. In the illustrated embodiment, the renewable naphtha processing system 300 includes introduction of the renewable naphtha 116 into analyzer 118 to measure the octane number of renewable naphtha 116. In some embodiments, routing of the renewable naphtha 116 to downstream units is dependent on octane number. If the renewable naphtha has an octane number, for example, above a target octane number (e.g., octane number of 30), either as RON (research octane number), MON (motor octane number), or by the (RON+MON)/2 method, the renewable naphtha 116 may be routed to gasoline blending pool 322 via stream 302. In some embodiments, a target octane number is selected as a cutoff for determining whether the renewable naphtha is suitable for directly sending to the gasoline blending pool 322. Gasoline is typically a blend of various intermediate refinery streams which are blended routed to form various grades of gasoline which have the correct properties for the season and geographical area which the gasoline is produced in or sold in. Some properties of gasoline include octane number and Reid vapor pressure, for example, which may be set by regulation. The gasoline blending pool refers to a facility which has equipment for storage and blending gasoline. In general, the gasoline blending pool may accept intermediate refinery streams such as FCC gasoline, reformate, alkylate, isomerate, straight run naphtha, and renewable naphtha as input and the blending equipment may blend the intermediate streams to form gasolines with the required properties.

If the renewable naphtha 116 has an octane number below the required octane to be send to gasoline blending pool 322, for example, the renewable naphtha is introduced into separator 304 by stream 120. Separator 304 may be any equipment suitable for separating components of stream 120 such as a separator, a stripper, or a fractionator, for example. In some embodiments, separator 304 separates stream 304 into stream 306 which contains a majority of the C6 and below hydrocarbons in stream 120 and stream 308 which contains a majority of the C7+ hydrocarbons in stream 120. In the illustrated embodiments, stream 308 is introduced into catalytic reforming unit 318, for example, whereby the C7+ hydrocarbons are contacted with a reforming catalyst. In reforming unit 318, example embodiments include the C7+ hydrocarbons undergoing several reactions including dehydrogenation of naphthenic hydrocarbons to form aromatics, isomerization of paraffins, dehydrocyclization of paraffins, and hydrocracking to produce reformate stream 320, for example, which is then sent to gasoline blending pool 322. In some embodiments, another product from reforming includes hydrogen which may be integrated with a diesel hydrotreating system.

In some embodiments, catalytic reforming unit 318 includes a reforming catalyst. In some embodiments, the reforming catalyst includes high purity alumina base impregnated with platinum and metallic activators. The reforming catalyze may include modified zeolitic catalysts. Modified zeolitic catalyst as disclosed herein may be prepared from a zeolite, herein referred to as a “precursor zeolite” or a “zeolite.” As used herein, “precursor zeolite,” “zeolite,” or “zeolitic” (and grammatical variations thereof) are defined to refer to a crystalline material having a porous framework structure built from tetrahedral atoms connected by bridging oxygen atoms. A precursor zeolite is modified to produce a modified zeolite as described herein, which is subsequently converted to a modified zeolitic catalyst disclosed herein. Thus, the modified zeolites are precursor zeolites that have been treated in such a way that the one or more of the bulk silica-to-alumina ratio and framework silica-to-alumina ratio is increased relative to the precursor zeolite bulk silica-to-alumina ratio and framework silica-to-alumina ratio. Examples of known zeolite frameworks are given in the “Atlas of Zeolite Frameworks” published on behalf of the Structure Commission of the International Zeolite Association”, revised edition, Ch. Baerlocher, L. B. McCusker, D. H. Olson, eds., Elsevier, New York (2007). Under this definition, a zeolite can refer to aluminosilicates having a zeolitic framework type as well as crystalline structures containing oxides of heteroatoms different from silicon and aluminum. Such heteroatoms can include any heteroatom generally known to be suitable for inclusion in a zeolitic framework, such as gallium, boron, germanium, phosphorus, zinc, antimony, tin, and/or other transition metals that can substitute for silicon and/or aluminum in a zeolitic framework. A zeolite may be referred to by the number of tetrahedral atoms (exclusive of oxygen atoms) that define pore openings in the zeolite. For example, a precursor zeolite may be an 8-member ring zeolite, a 10-member ring zeolite, or a 12-member ring zeolite. Preferably, a precursor zeolite is a 12-member ring zeolite. A precursor zeolite may be a three-dimensional zeolite. Examples of suitable precursor zeolites include zeolites having a FAU, LTL, BEA, MAZ, MTW, MET, MOR, or EMT-FAU intermediate framework structure. Examples of suitable precursor zeolites having an FAU framework structure include, but are not limited to, USY (or dehydrated USY), Na—X (or dehydrated Na—X), LZ-210, Li-LSX, zeolite X, and zeolite Y. Examples of suitable precursor zeolites having an LTL framework structure include, but are not limited to, zeolite L, gallosillicate L, LZ-212 and perlialite. Examples of suitable precursor zeolites having a BEA framework structure include, but are not limited, to Beta, Al-rich Beta, CIT-6, and pure silica Beta. Examples of suitable precursor zeolites having an MAZ framework structure include, but are not limited to, mazzite, LZ-202, and ZSM-4. Examples of suitable precursor zeolites having an MTW framework structure include, but are not limited to, ZSM-12, CZH-5, NU-13, TPZ-12, Theta-3, and VS-12. Examples of suitable precursor zeolites having an MET framework structure include, but are not limited to, ZSM-18 and ECR-40. Examples of suitable precursor zeolites having an MOR framework structure include, but are not limited to, Ca-Q, LZ-211, mordenite, and Na-D. Examples of suitable precursor zeolites having an EMT-FAU intermediate structure include, but are not limited to, CSZ-1, ECR-30, ECR-32, ZSM-20, and ZSM-3. A precursor zeolite may be a zeolite L, zeolite Y, or USY. A person of ordinary skill in the art knows how to make the aforementioned frameworks. Zeolites, being an aluminosilicate material, have a framework silica-to-alumina ratio and bulk silica-to-alumina ratio. As used herein, “bulk silica-to-alumina ratio” refers to the silicato-alumina ratio of a zeolite inclusive of alumina within and outside the framework (extra framework alumina). As used herein, “framework silica-to-alumina ratio” refers to the silica-to alumina ratio of a zeolite of tetrahedrally coordinated alumina within the framework and exclusive of alumina outside the framework (extra-framework alumina, which is typically octahedrally coordinated). The bulk silica-to-alumina ratio, framework silica-to-alumina ratio, and extra framework metal oxide content, unless otherwise indicated, are measured on a modified zeolitic catalyst (defined below) after all modifications, for example, after steaming, silicone selectivation and/or acid/base washing of a precursor zeolite. Framework silica-to-alumina ratio may be measured by solid state NMR. Bulk silica-to alumina ratio may be measured by any elemental analysis technique, for example, inductively coupled plasma atomic emission spectroscopy or inductively coupled plasma mass spectrometry. Processes for producing modified zeolites include, for example, steaming a precursor zeolite. In such processes, a precursor zeolite may be steamed in an atmosphere comprising steam at a temperature of about 750° F. (398.9° C.) to about 3000° F. (1649° C.), about 1000° F. (537.8° C.) to about 2000° F. (1093° C.), or about 1500° F. (815.6° C.) to about 1800° F. (982.2° C.). The atmosphere can include as little as about 1 vol. % water and up to about 100 vol. % water. A precursor zeolite can be exposed to steam for any convenient period of time, such as about 10 minutes to about 48 hours. In particularly useful examples, a precursor zeolite is steamed for about 1 hour to about 5 hours at a temperature of about 1500° F. (815.6° C.) to about 1800° F. (982.2° C.), which includes about 1500° F. 815.6° C.), 1600° F. 871.1° C.), 1700° F. 926.7° C.), 1800° F. 982.2° C.). A precursor zeolite may be steamed multiple times, if desired, to produce a modified zeolite. If steamed multiple times, each steam treatment can occur with other steps performed between steam treatments, for example, acid washing. Typical acid leaching conditions can include using a suitable acid, such oxalic acid, citric acid, or nitric acid, in concentrations ranging from about 0.1 molar up to about 10 molar, preferably about 1 molar, at a temperature ranging from about 20° C. up to about 100° C. Advantageously, a modified zeolitic catalyst may favor paraffin dehydrocyclization over other reforming reactions such as, but not limited to, isomerization, cracking, and dealkylation. Enhanced selectivity for paraffin dehydrocyclization may be imparted to a modified zeolitic catalyst by adjusting the framework and/or bulk silica-to-alumina ratio of the precursor zeolite from which the modified zeolitic catalyst is derived. A modified zeolite suitable for preparing a modified zeolitic catalyst may have a high bulk silica-to-alumina ratio, for example, at least about 40:1 (e.g., about 40:1 to about 10000:1), at least about 80:1 (e.g., about 80:1 to about 15 10000:1), at least about 350:1 (e.g., about 350:1 to about 10000:1), or at least about 400:1 (e.g., about 400:1 to about 10000:1). A modified zeolite may have a high framework silica-to-alumina ratio, for example, at least about 80:1 (e.g., about 80:1 to about 20000:1), at least about 500:1 (e.g., about 500:1 to about 20000:1), or at least about 2000:1 (e.g., about 2000:1 to about 20000:1). Preferably, a modified zeolite has a framework silica-to-alumina ratio of at least about 500:1 or about 2000:1. A modified zeolite may be treated with a source of one or more transition metals to form a modified zeolitic catalyst described herein. A modified zeolitic catalyst may include at least about 0.01 wt. %, at least about 0.05 wt. %, at least about 0.25 wt. %, at least about 1 wt. %, at least about 2.5 wt. %, at least about 5 wt. %, at least about 10 wt. %, or in a range from about 25 0.01 wt. % to about 10 wt. %, about 0.01 wt. % to about 5.0 wt. %, 0.01 wt. % to 2.5 wt. %, about 0.01 wt. % to about 1 wt. %, about 0.01 wt. % to about 0.25 wt. %, about 0.01 wt. % to about 0.05 wt. %, about 0.05 wt. % to about 10 wt. %, about 0.05 wt. % to about 5.0 wt. %, about 0.05 wt. % to about 2.5 wt. %, about 0.05 wt. % to about 1 wt. %, about 0.05 wt. % to about 0.25 wt. %, about 0.25 wt. % to 10 wt. %, about 0.25 wt. % to about 5 wt. %, about 0.25 wt. % to about 1 wt. 30%, about 1 wt. % to about 10 wt. %, about 1 wt. % to about 5 wt. %, about 1 wt. % to about 2.5 wt. %, about 2.5 wt. % to about 10 wt. %, about 2.5 wt. % to about 5 wt. %, or about 5 wt. % to about 10 wt. % transition metal, based on the total weight of the modified zeolitic catalyst. For example, a modified zeolitic catalyst may include about 0.9 wt. % of a transition metal. The transition metal may be a Group 10 transition metal, for example, nickel (Ni), palladium (Pd), platinum (Pt), or a combination thereof. Suitable sources of platinum include, but are not limited to, tetraamine platinum (II) nitrate, tetraamine platinum hydroxide, chloroplatinic acid, and the like. Typical methods for incorporation of a metal include impregnation (such as by incipient wetness), ion exchange, deposition by precipitation, and any other convenient method for depositing a metal. Optionally, a modified zeolitic catalyst may include one or more Group 1 metals and/or Group 2 metals. For example, a modified zeolite or modified zeolitic catalyst may include, based on total weight of the modified zeolitic catalyst, about 0.005 wt. % to about 10 wt. %, about 0.005 wt. % to about 5 wt. %, about 0.005 wt. % to about 1 wt. %, about 0.005 wt. % to about 0.5 wt. %, 10 about 0.005 wt. % to about 0.01 wt. %, about 0.01 wt. % to about 10 wt. %, about 0.01 wt. % to about 5 wt. %, about 0.01 wt. % to about 1 wt. %, about 0.01 wt. % to about 0.5 wt. %, about 0.5 wt. % to about 10 wt. %, about 0.5 wt. % to about 5 wt. %, about 0.5 wt. % to about 1 wt. %, about 1 wt. % to about 10 wt. %, about 1 wt. % to about 5 wt. %, or about 5 wt. % to about 10 wt. % of a Group 1 or Group 2 metal. The Group 1 metal may be lithium (Li), sodium (Na), potassium (K), rubidium (Rb), or cesium (Ce). The Group 2 metal may be beryllium (Be), magnesium (Mg), calcium (Ca), strontium (Sr), or barium (Ba). For example, a modified zeolitic catalyst may comprise from about 0.05 wt. % to about 0.25 wt. % magnesium. This may be carried out by any method known in the art, for example, ion exchange, Muller addition, impregnation, or the like. A Group 1 metal and/or Group 2 metal may be doped onto a precursor zeolite to form a metal-doped zeolite or onto a modified zeolite, either of which may be further converted into a zeolitic catalyst precursor, then into a modified zeolitic catalyst. Optionally, a modified zeolite, a metal-doped zeolite, or zeolitic catalyst precursor may be combined with a support or binder material (both are referred to as a “binder” herein) to form a modified zeolitic catalyst. A modified zeolitic catalyst may include from about 1 wt. % to about 20 wt. %, about 1 wt. % to about 30 wt. %, about 1 wt. % to about 40 wt. %, about 1 wt. % to about 50 wt. %, about 1 wt. % to about 60 wt. %, about 1 wt. % to about 70 wt. %, about 1 wt. % to about 80 wt. %, about 1 wt. % to about 90 wt. %, about 1 wt. % to about 99 wt. %, about 10 wt. % to about 20 wt. %, about 10 wt. % to about 30 wt. %, about 10 wt. % to about 40 wt. %, about 10 wt. % to about 50 wt. %, about 10 wt. % to about 60 wt. %, about 10 wt. 30 to about 70 wt. %, about 10 wt. % to about 80 wt. %, about 10 wt. % to about 90 wt. %, about 10 wt. % to about 99 wt. %, about 20 wt. % to about 30 wt. %, about 20 wt. % to about 40 wt. %, about 20 wt. % to about 50 wt. %, about 20 wt. % to about 60 wt. %, about 20 wt. % to about 70 wt. %, about 20 wt. % to about 80 wt. %, about 20 wt. % to about 90 wt. %, about 20 wt. % to about 99 wt. %, about 30 wt. % to about 40 wt. %, about 30 wt. % to about 50 wt. %, about 30 wt. % to about 60 wt. %, about 30 wt. % to about 70 wt. %, about 30 wt. % to about 80 wt. %, about 30 wt. % to about 90 wt. %, about 30 wt. % to about 99 wt. %, about 40 wt. % to about 50 wt. %, about 40 wt. % to about 60 wt. %, about 40 wt. % to about 70 wt. %, about 40 wt. % to about 80 wt. %, about 40 wt. % to about 90 wt. %, about 40 wt. % to about 99 wt. %, about 50 wt. % to about 60 wt. %, about 50 wt. % to about 70 wt. %, about 50 wt. % to about 80 wt. %, about 50 wt. % to about 90 wt. %, about 50 wt. % to about 99 wt. %, about 60 wt. % to about 70 wt. %, about 60 wt. % to about 80 wt. %, about 60 wt. % to about 90 wt. %, about 60 wt. % to about 99 wt. %, about 70 wt. % to about 80 wt. %, about 70 wt. % to about 90 wt. %, about 70 wt. % to about 99 wt. %, about 80 wt. % to about 90 wt. %, about 80 wt. % to about 99 wt. %, or about 90 wt. % to about 99 wt. % binder based on total weight of the modified zeolitic catalyst. A suitable modified zeolite-to-binder ratio may be about 10:1, about 4:1, about 2:1, about 1:1, about 1:2, about 1:4, or about 1:10. Examples of suitable binders include other zeolites, other inorganic materials such as clays and metal oxides such as alumina, silica, silica-alumina, titania, zirconia, Group 1 metal oxides, Group 2 metal oxides, and combinations thereof. Clays may be kaolin, bentonite, and montmorillonite and may be sourced commercially. They may be blended with other materials such as silicates. Other suitable binders may include binary porous matrix materials (such as silicamagnesia, silica-thoria, silica-zirconia, silica-beryllia and silica-titania), and ternary materials (such as silica-alumina-magnesia, silica-alumina-thoria and silica-alumina-zirconia). One or more binders may be used in a modified zeolitic catalyst described herein, for example, silica and alumina may be used in combination. Preferably, however, the binder is silica. Optionally, one or more promoters may be present in a modified zeolitic catalyst described herein. For example, a modified zeolitic catalyst may include at least about 0.005 wt. % to about 10 wt. %, about 0.005 wt. % to about 5 wt. %, about 0.005 wt. % to about 1 wt. %, about 0.005 wt. % to about 0.5 wt. %, about 0.005 wt. % to about 0.01 wt. %, about 0.01 wt. % to about 10 wt. %, about 0.01 wt. % to about 5 wt. %, about 0.01 wt. % to about 1 wt. %, about 0.01 wt. % to about 0.5 wt. %, about 0.5 wt. % to about 10 wt. %, about 0.5 wt. % to about 5 wt. %, about 0.5 wt. % to about 1 wt. %, about 1 wt. % to about 10 wt. %, about 1 wt. % to about 5 wt. %, or about 5 wt. % to about 10 wt. % of a promoter based on total weight of the modified zeolitic catalyst. The promoter may be a Group 3 metal, a Group 4 metal, a Group 5 metal, a Group 6 metal, a Group 7 metal, a Group 8 metal, a Group 9 metal, a Group 10 metal, a Group 11 metal, a Group 13 metal, and a Group 14 metal. Examples of promoters include, but are not limited to, scandium (Sc), tin (Sn), vanadium (V), chromium (Cr), manganese (Mn), iron (Fe), cobalt (Co), nickel (Ni), zinc (Zn), palladium (Pd), gallium (Ga), iridium (Jr), indium (In), germanium (Ge), rhodium (Rh), ruthenium (Ru), and copper (Cu). Promoters may be incorporated from about 0.005 wt. % to about 15 wt. % by any method well known in the art, for example, impregnation, Muller addition, ion exchange, and the like. Optionally, the modified zeolite in a modified zeolitic catalyst may be present at least partly in hydrogen form. This can readily be achieved, for example, by ion exchange to convert the modified zeolite to the ammonium form, followed by calcination in air or an inert atmosphere at a temperature from about 400° C. to about 1000° C. to convert the ammonium form to the active hydrogen form. If an organic structure-directing agent is used in the synthesis of a zeolite, additional calcination may be desirable to remove the organic structure-directing agent. Optionally, a modified zeolitic catalyst may include one or more selectivating agents to introduce diffusional limitations to a modified zeolitic catalyst. Silicone selectivation can be performed with any suitable silicone oil or from an organic silica source such as tetraethyl orthosilicate (TEOS). As used herein, a selectivating agent refers to an agent that prevents unwanted activity derived from sites on the modified zeolite's external surface. A zeolitic catalyst precursor may be calcined, reduced (e.g., in H2) and/or sulfided by methods well known in the art to yield a modified zeolitic catalyst. Sulfidation can be performed by any convenient method, such as gas phase sulfidation or liquid phase sulfidation. Catalytic reforming is performed, for example, by exposing the C7+ hydrocarbons from stream 308 to a reforming catalyst under conditions effective to convert a portion of the C7+ hydrocarbons to reformate. Examples of effective reforming conditions include, but are not limited to, a temperature of 900° F. (482° C.) or higher, for example, 920° F. (493° C.) or higher, 940° F. (504° C.) or higher, 960° F. (515° C.), or 980° F. (526° C.) or higher. Examples of effective reforming conditions additionally or alternately include, but are not limited to, a total pressure of 175 psig (1.2 MPag) or more, for example, 180 psig (1.24 Mpag) or more, 185 psig (1.27 MPag) or more, or 190 psig (1.31 MPag) or more.

In the illustrated embodiment, stream 306 from separator 304 is introduced into analyzer 324 to measure the octane number and iso/normal ratio of stream 306. Analyzer 324 may include any analyzers previously discussed. In some embodiments, analyzer 324 is the same type of analyzer as analyzer 118. Gasoline may be blended with light naphtha species such as C5 and C6 hydrocarbons. However, n-C5 and n-C6 hydrocarbons may have a low octane number and may be unsuitable to include in gasoline blends. Iso-C5 and iso-C6 generally have higher octane values than the corresponding n-paraffins making them more suitable for inclusion in gasoline blends. If the octane number of stream 306 is above a target octane number (e.g., 30), for example, the C6 and below hydrocarbons from stream 306 are be routed to the gasoline blending pool 322 via stream 310 in accordance with one or more embodiments. If stream 306 does not have an octane number above the required octane to be send to gasoline blending pool 322, for example, the C6 and below hydrocarbons from stream 306 are routed to isomerization unit 314, in accordance with one or more embodiments. In isomerization unit 314, examples embodiments include contacting the C6 and below hydrocarbons with an isomerization catalyst to convert a portion of the C6 and below hydrocarbons from stream 306 to their corresponding iso-paraffins. In some embodiments, isomerized stream 320 from isomerization unit 314 are routed to gasoline blending pool 322 via stream 316.

In some embodiments, isomerization unit 314 includes an isomerization catalyst. In some embodiments, the isomerization catalyst includes platinum impregnated chlorinated alumina or zeolites. Isomerization is performed, for example, by exposing the C6 and below hydrocarbons from stream 312 to an isomerization catalyst under conditions effective to convert a portion of the C6 and below hydrocarbons to the corresponding iso-paraffins. Examples of effective isomerization conditions include, but are not limited to, a temperature of 300° F. (149° C.) or higher, for example, 320° F. (160° C.) or higher, or 340° F. (171° C.) or higher. Examples of effective isomerization conditions additionally or alternately include, but are not limited to, a total pressure of 400 psig (2.75 MPag) or more, for example, 420 psig (2.9 Mpag) or more, 440 psig (3. MPag) or more, or 450 psig (3.1 MPag) or more.

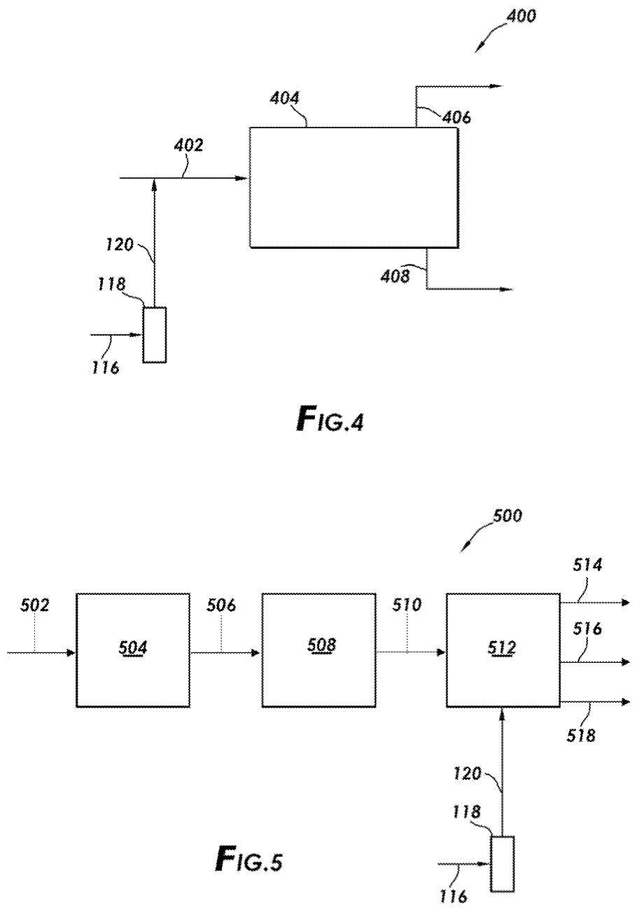

FIG. 4 depicts an example renewable naphtha processing system integrated with an iso/normal separation processing system 400 accordance with one or more embodiments. In the illustrated embodiments, renewable naphtha 116 is introduced into analyzer 118 to measure the octane number of renewable naphtha 116. In the illustrated embodiment, stream 120 is combined with feed 402 before introduction into iso/normal separator 404. Feed 402 includes, for example, an effluent from an upstream unit and may include iso and normal hydrocarbons. Iso/normal separator 404 may include any equipment suitable for separating iso and normal paraffins such as stripper, distillation column, flash drum, or any other equipment suitable for separating iso and normal hydrocarbons to produce stream 406 comprising a majority of the iso hydrocarbons from stream 402 and stream 408 comprising a majority of the normal hydrocarbons from stream 402. In some embodiments, the iso/normal separator 404 includes zeolites and/or membranes. In some embodiments, the iso/normal separator 404 is shape selective.

FIG. 5 depicts an example renewable naphtha integrated with a jet production system 500 accordance with one or more embodiments. In the illustrated embodiment, a triglyceride stream 502 is introduced into hydrodeoxygenation unit 504. Triglyceride stream 502 includes, for example, any triglycerides suitable for production of renewable jet fuel. In hydrodeoxygenation unit 502, examples embodiments include reaction of triglycerides from triglyceride stream 502 with hydrogen to produce a hydrocarbon stream 506 corresponding to the triglycerides in stream 502. In the illustrated embodiment, the hydrocarbon stream 506 is introduced into hydrocracker 508 whereby the hydrocarbons from stream 506 are selectively hydrocracked, for example, to an intermediate product stream 510 comprising renewable naphtha, renewable jet fuel, and, in some embodiments, renewable diesel. In the illustrated embodiment, the intermediate product stream 510 is introduced into product fractionator 512. In the illustrated embodiment, renewable naphtha 116 is introduced into analyzer 118 and routed to product fractionator 512. Alternatively, or in addition to, the renewable naphtha may be mixed with hydrocarbon steam 506 prior to introduction into hydrocracker 508. Product fractionator 512 separates, for example, renewable naphtha in stream 120 and components of intermediate product stream 510 into renewable naphtha stream 514 comprising the renewable naphtha portion of intermediate product stream 512 and renewable naphtha from stream 120, renewable jet stream 516 comprising the renewable jet portion of intermediate product stream 512, and renewable diesel stream 518 comprising the renewable diesel portion of intermediate product stream 512.

### ADDITIONAL EMBODIMENTS

Accordingly, the preceding description describes utilization of an analyzer to monitor conversion of the biofeedstock in a first hydrotreating stage to avoid catalyst poisoning in a subsequent stage. The apparatus, systems, and methods disclosed herein may include any of the various features disclosed herein, including one or more of the following embodiments.

Embodiment 1. A method of processing a biofeedstock, comprising: hydrotreating the biofeedstock by reaction with hydrogen to form a hydrotreated biofeedstock; contacting at least a portion of the hydrotreated biofeedstock with a dewaxing catalyst to produce a renewable diesel product and a renewable naphtha product; separating the renewable diesel product and the renewable naphtha product in a product splitter; and monitoring an octane number of the renewable naphtha product with an analyzer.

Embodiment 2. The method of embodiment 1, wherein the biofeedstock comprises at one component selected from the group consisting of a vegetable oil, an animal fat, a fish oil, a pyrolysis oil, algae lipid, an algae oil, and combinations thereof.

Embodiment 3. The method of any of embodiments 1-2, wherein the biofeedstock comprises lipid compounds.

Embodiment 4. The method of embodiments 1-3, wherein the hydrotreated biofeedstock comprises paraffin products.

Embodiment 5. The method of embodiments 1-4, wherein the analyzer comprises an octane sensor an infrared spectrometer, a near infrared spectrometer, or a Raman spectrometer.

Embodiment 6. The method of embodiments 1-5, wherein the analyzer comprises an offline analyzer, an at line analyzer, an online analyzer, or an inline analyzer.

Embodiment 7. The method of embodiments 1-6, wherein the analyzer is positioned after the product splitter.

Embodiment 8. The method of embodiments 1-7, further comprising comparing the octane number of the renewable naphtha product to a first target octane number and routing the renewable naphtha product to a gasoline blending pool if the octane number of the renewable naphtha product meets or exceeds the first target octane number.

Embodiment 9. The method of embodiments 1-8, further comprising: comparing the octane number of the renewable naphtha product to a first target octane number and routing the renewable naphtha product to an intermediate separator if the octane number of the renewable naphtha product does not meet or exceed the first target octane number; separating the renewable naphtha product to produce a light stream comprising C6 and below hydrocarbons and a heavy stream comprising C7+ hydrocarbons; and introducing the heavy stream into a catalytic reformer and contacting the heavy stream with a reforming catalyst to convert at least a portion of the heavy stream to a reformate product.

Embodiment 10. The method of embodiment 9, further comprising: comparing the octane number of the light stream to a second target octane number and routing the light stream comprising C6 and below hydrocarbons to a gasoline blending pool if the octane number of the light stream meets or exceeds the second target octane number.

Embodiment 11. The method of embodiment 9, further comprising: comparing the octane number of the light stream to a second target octane number and introducing the light stream to an isomerization unit if the octane number of the light stream does not meet or exceed the second target octane number; contacting the light stream with an isomerization catalyst in the isomerization unit to produce an isomerized steam; and routing the isomerized stream to a gasoline blending pool.

Embodiment 12. The method of embodiments 1-11, further comprising introducing the renewable naphtha product into an iso/normal splitter and separating a steam comprising iso-paraffins and a stream comprising n-paraffins.

Embodiment 13. The method of embodiments 1-12, further comprising: introducing a triglyceride stream into a hydrodeoxygenation reactor and reacting triglycerides from the triglyceride stream with hydrogen in the presence of a hydrodeoxygenation catalyst to produce a hydrocarbon stream comprising hydrocarbons corresponding to the triglycerides; introducing the hydrocarbon stream and the renewable naphtha product into a hydrocracker and hydrocracking the hydrocarbon stream and renewable naphtha product with hydrogen in the presence of a hydrocracking catalyst to produce and intermediate product stream comprising naphtha and renewable jet fuel; introducing the intermediate product into a product fractionator and generating a naphtha stream comprising the naphtha from the intermediate product stream and the renewable naphtha product, a renewable jet fuel stream comprising the renewable jet fuel from the intermediate product stream.

Embodiment 14. A system for production of renewable naphtha comprising: a hydrotreatment stage comprising a hydrodeoxygenation reactor that receives a biofeedstock; a dewaxing stage comprising a dewaxing reactor that receives a hydrotreated product stream from the hydrotreatment stage and generates a dewaxed product stream, and a product separator that receives the dewaxed product stream from the dewaxing reactor and generates a renewable diesel stream and a renewable naphtha stream; and an analyzer positioned to analyze the renewable naphtha stream.

Embodiment 15. The system of embodiment 14, wherein the biofeedstock comprises lipid compounds.

Embodiment 16. The system of any of embodiments 14-15, wherein the hydrotreated biofeedstock comprises paraffin products.

Embodiment 17. The system of embodiments 14-16, wherein the analyzer comprises an octane sensor.

Embodiment 18. The system of embodiments 14-17, wherein the analyzer measures an octane number of the renewable naphtha stream.

Embodiment 19. The system of embodiments 14-18, further comprising: a separator operable to generate a light stream comprising C6 and below hydrocarbons from the renewable naphtha stream and a heavy stream comprising C7+ hydrocarbons from the renewable naphtha stream.

Embodiment 20. The system of embodiments 19, further comprising: an isomerization unit that receives the light stream and generates an isomerized stream; and a reforming unit that receives the heavy stream and generates a reformate stream.

### Examples

To facilitate a better understanding of the present disclosure, the following examples of certain aspects of some embodiments are given. In no way should the following examples be read to limit, or define, the entire scope of the disclosure.

A renewable diesel plant naphtha was analyzed in the winter and summer configuration. The analysis is shown in Table 1.

TABLE 1

| | Winter | Summer |
|---|---|---|
| Paraffins | 36.8 | 50.6 |
| Isoparaffins | 59.5 | 37.5 |
| Aromatics | 0.7 | 2 |
| Naphthenes | 1.8 | 3.8 |
| Olefins | 0.5 | 0.7 |
| Oxygenates | 0 | 0 |
| Unidentified | 0.7 | 5.4 |
| Carbon Group (w/>0.5%) | C4-C10 | C5-C11 |

It was observed that the composition of naphtha varied from winter to summer.

While the invention has been described with respect to a number of embodiments and examples, those skilled in the art, having benefit of this disclosure, will appreciate that other embodiments can be devised which do not depart from the scope and spirit of the invention as disclosed herein. Although individual embodiments are discussed, the invention covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

The phrase “major amount” or “major component” as it relates to components included within the renewable diesel of the specification and the claims means greater than or equal to 50 wt. %, or greater than or equal to 60 wt. %, or greater than or equal to 70 wt. %, or greater than or equal to 80 wt. %, or greater than or equal to 90 wt. % based on the total weight of the thermal management fluid. The phrase “minor amount” or “minor component” as it relates to components included within the renewable diesel of the specification and the claims means less than 50 wt. %, or less than or equal to 40 wt. %, or less than or equal to 30 wt. %, or greater than or equal to 20 wt. %, or less than or equal to 10 wt. %, or less than or equal to 5 wt. %, or less than or equal to 2 wt. %, or less than or equal to 1 wt. %, based on the total weight of the thermal management fluid. The phrase “substantially free” or “essentially free” as it relates to components included within the renewable diesel of the specification and the claims means that the particular component is at 0 weight % within the renewable diesel, or alternatively is at impurity type levels within the renewable diesel (less than 100 ppm, or less than 20 ppm, or less than 10 ppm, or less than 1 ppm).

All numerical values within the detailed description herein are modified by “about” the indicated value, and take into account experimental error and variations that would be expected by a person having ordinary skill in the art.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited.

What is claimed is:

1. A method of processing a biofeedstock, comprising:
hydrotreating the biofeedstock by reaction with hydrogen to form a hydrotreated biofeedstock;
contacting at least a portion of the hydrotreated biofeedstock with a dewaxing catalyst to produce a renewable diesel product and a renewable naphtha product;
separating the renewable diesel product and the renewable naphtha product in a product splitter; and
monitoring an octane number of the renewable naphtha product with an analyzer.

2. The method of claim 1, wherein the biofeedstock comprises at one component selected from the group consisting of a vegetable oil, an animal fat, a fish oil, a pyrolysis oil, algae lipid, an algae oil, and combinations thereof.

3. The method of claim 1, wherein the biofeedstock comprises lipid compounds.

4. The method of claim 1, wherein the hydrotreated biofeedstock comprises paraffin products.

5. The method of claim 1, wherein the analyzer comprises an octane sensor an infrared spectrometer, a near infrared spectrometer, or a Raman spectrometer.

6. The method of claim 1, wherein the analyzer comprises an offline analyzer, an at line analyzer, an online analyzer, or an inline analyzer.

7. The method of claim 1, wherein the analyzer is positioned after the product splitter.

8. The method of claim 1, further comprising comparing the octane number of the renewable naphtha product to a first target octane number and routing the renewable naphtha product to a gasoline blending pool if the octane number of the renewable naphtha product meets or exceeds the first target octane number.

9. The method of claim 1, further comprising:
comparing the octane number of the renewable naphtha product to a first target octane number and routing the renewable naphtha product to an intermediate separator if the octane number of the renewable naphtha product does not meet or exceed the first target octane number;
separating the renewable naphtha product to produce a light stream comprising C6 and below hydrocarbons and a heavy stream comprising C7+ hydrocarbons; and
introducing the heavy stream into a catalytic reformer and contacting the heavy stream with a reforming catalyst to convert at least a portion of the heavy stream to a reformate product.

10. The method of claim 9, further comprising:
comparing the octane number of the light stream to a second target octane number and routing the light stream comprising C6 and below hydrocarbons to a gasoline blending pool if the octane number of the light stream meets or exceeds the second target octane number.

11. The method of claim 9, further comprising:
comparing the octane number of the light stream to a second target octane number and introducing the light stream to an isomerization unit if the octane number of the light stream does not meet or exceed the second target octane number;
contacting the light stream with an isomerization catalyst in the isomerization unit to produce an isomerized steam; and
routing the isomerized stream to a gasoline blending pool.

12. The method of claim 1, further comprising introducing the renewable naphtha product into an iso/normal splitter and separating a steam comprising iso-paraffins and a stream comprising n-paraffins.

13. The method of claim 1, further comprising:
introducing a triglyceride stream into a hydrodeoxygenation reactor and reacting triglycerides from the triglyceride stream with hydrogen in the presence of a hydrodeoxygenation catalyst to produce a hydrocarbon stream comprising hydrocarbons corresponding to the triglycerides;
introducing the hydrocarbon stream and the renewable naphtha product into a hydrocracker and hydrocracking the hydrocarbon stream and renewable naphtha product with hydrogen in the presence of a hydrocracking catalyst to produce and intermediate product stream comprising naphtha and renewable jet fuel;
introducing the intermediate product into a product fractionator and generating a naphtha stream comprising the naphtha from the intermediate product stream and the renewable naphtha product, a renewable jet fuel stream comprising the renewable jet fuel from the intermediate product stream.

14. A system for production of renewable naphtha comprising:
a hydrotreatment stage comprising a hydrodeoxygenation reactor that receives a biofeedstock;
a dewaxing stage comprising a dewaxing reactor that receives a hydrotreated product stream from the hydrotreatment stage and generates a dewaxed product stream, and a product separator that receives the dewaxed product stream from the dewaxing reactor and generates a renewable diesel stream and a renewable naphtha stream; and
an analyzer positioned to analyze the renewable naphtha stream.

15. The system of claim 14, wherein the biofeedstock comprises lipid compounds.

16. The system of claim 14, wherein the hydrotreated biofeedstock comprises paraffin products.

17. The system of claim 14, wherein the analyzer comprises an octane sensor.

18. The system of claim 14, wherein the analyzer measures an octane number of the renewable naphtha stream.

19. The system of claim 14, further comprising:
a separator operable to generate a light stream comprising C6 and below hydrocarbons from the renewable naphtha stream and a heavy stream comprising C7+ hydrocarbons from the renewable naphtha stream.

20. The system of claim 19, further comprising:
an isomerization unit that receives the light stream and generates an isomerized stream; and
a reforming unit that receives the heavy stream and generates a reformate stream.
